(19) United States
(12) Patent Application Publication
(10) Pub. No.: US 2025/0191830 A1
(43) Pub. Date: Jun. 12, 2025

(54) MULTILAYER COIL COMPONENT

(71) Applicant: TDK Corporation, Tokyo (JP)

(72) Inventors: Yuto SHIGA, Tokyo (JP); So KOBAYASHI, Tokyo (JP); Teru ISHIMORI, Tokyo (JP)

(73) Assignee: TDK Corporation, Tokyo (JP)

(21) Appl. No.: 18/974,134

(22) Filed: Dec. 9, 2024

(30) Foreign Application Priority Data
Dec. 12, 2023 (JP) 2023-209392

(51) Int. Cl. H01F 27/28; H01F 27/29

(52) U.S. Cl. CPC H01F 27/2804; H01F 27/292; H01F 2027/2809

(57) ABSTRACT

A multilayer coil component includes an element body, a coil, an external electrode, and a connection conductor. A first coil conductor and a second coil conductor include a first connection portion. A plurality of coil conductors include a plurality of second connection portions. In the first connection portion, the first coil conductor and the second coil conductor overlap each other and are physically connected to each other. In the plurality of second connection portions, adjacent coil conductors among the plurality of coil conductors overlap each other and are physically connected to each other. The first coil conductor has a path length longer than a path length of the second coil conductor. An area of the first connection portion as viewed from a direction is larger than the smallest area among areas of the plurality of second connection portions as viewed from the direction.

### CROSS-REFERENCE TO RELATED APPLICATIONS

This application is based upon and claims the benefit of priority from Japanese Patent Application No. 2023-209392, filed On Dec. 12, 2023, the entire contents of which are incorporated herein by reference.

### BACKGROUND

### Field

The present invention relates to a multilayer coil component.

### Description of the Related Art

Known a multilayer coil component includes an element body, a coil disposed in the element body, an external electrode disposed on a surface of the element body, and a connection conductor disposed in the element body (for example, Japanese Unexamined Patent Publication No. 2018-113309). The connection conductor electrically connects the coil and the external electrode to each other. The coil includes a first coil conductor located in the same layer as the connection conductor and a plurality of coil conductors arranged in a direction. The plurality of coil conductors includes a second coil conductor adjacent to the first coil conductor in the direction.

### SUMMARY

An object of an aspect of the present disclosure is to provide a multilayer coil component capable of improving quality factor (Q factor).

A multilayer coil component according to one aspect of the present disclosure includes an element body, a coil disposed in the element body, an external electrode disposed on a surface of the element body, and a connection conductor disposed in the element body. The connection conductor electrically connects the coil and the external electrode to each other. The coil includes a first coil conductor and a plurality of coil conductors. The first coil conductor is located at an end of the coil and is included in the same layer as the connection conductor. The plurality of coil conductors includes a second coil conductor adjacent to the first coil conductor in a direction and is arranged in the direction. The first coil conductor has a path length longer than a path length of the second coil conductor. The first coil conductor and the second coil conductor include a first connection portion where the first coil conductor and the second coil conductor overlap each other and are physically connected to each other. Adjacent coil conductors among the plurality of coil conductors include a plurality of second connection portions where the adjacent coil conductors overlap each other and are physically connected to each other. An area of the first connection portion as viewed from the direction is larger than the smallest area among areas of the plurality of second connection portions as viewed from the direction.

A Q factor of the multilayer coil component is proportional to a reciprocal of electric resistance. The electric resistance of the coil including the plurality of coil conductors depends on the combined resistance of coil conductors and connection portions where adjacent coil conductors are connected to each other. Since the electric resistance of a conductor is proportional to a length of the conductor and inversely proportional to a cross-sectional area of the conductor, electric resistance in the plurality of coil conductors varies in response to path lengths of the coil conductors and areas of the connection portions where the adjacent coil conductors overlap each other and are physically connected to each other. Therefore, the Q factor of the multilayer coil component depends on the path lengths of the plurality of coil conductors including the coil and the areas of the connection portions.

In the multilayer coil component, a plurality of inductance values is obtained for a predetermined outer shape size. Since the inductance value depends on the number of turns of the coil, a path length of each of the plurality of coil conductors including the coil is difficult to be fixed. The path length of each of the plurality of coil conductors is determined so that adjacent coil conductors do not form a loop. The connection portion where the coil conductor having a longer path length than of the other coil conductors is connected to an adjacent coil conductor can have an area larger than areas of connection portions where the other coil conductors are connected to each other.

In the one aspect described above, since the first coil conductor is located at the end of the coil, the first coil conductor is adjacent to the second coil conductor only in one orientation in the direction. Since the first coil conductor is not adjacent to a coil conductor in the other orientation, the path length is determined so that a loop is not formed only between the first and second coil conductors. The path length of the second coil conductor is determined so that a loop is not formed both between the first coil conductor and the second coil conductor and between the second coil conductor and the coil conductor to which the second coil conductor is adjacent in an orientation different from an orientation in which the second coil conductor is adjacent to the first coil conductor. Since restriction required for the path length of the first coil conductor is less than restriction required for the path length of the second coil conductor, the path length of the first coil conductor can be extended to be longer than the path length of the second coil conductor. As a result, the first coil conductor has the path length longer than the path length of the second coil conductor.

An area of the first connection portion as viewed from the direction is larger than the smallest area among areas of the plurality of second connection portions as viewed from the direction. Therefore, an electric resistance of the first connection portion is smaller than an electric resistance of the second connection portion having the smallest area among the plurality of second connection portions. As a result, since the combined resistance of the first coil conductor, the first connection portion, the plurality of coil conductors, and the plurality of second connection portions in the one aspect described above is smaller than the combined resistance in a configuration in which the first connection portion has an area equal to or less than the smallest area of the plurality of second connection portions. Therefore, the one aspect described above can improve the Q factor of the multilayer coil component.

A multilayer coil component according to another aspect of the present disclosure includes an element body, a coil disposed in the element body, an external electrode disposed on a surface of the element body, and a connection conductor disposed in the element body. The connection conductor electrically connects the coil and the external electrode to each other. The coil includes a first coil conductor and a plurality of coil conductors. The first coil conductor is located at an end of the coil and is included in the same layer as the connection conductor. The plurality of coil conductors includes a second coil conductor adjacent to the first coil conductor in a direction and is arranged in the direction. The first coil conductor has a path length longer than a path length of the second coil conductor. The first coil conductor and the second coil conductor include a first connection portion where the first coil conductor and the second coil conductor overlap each other and are physically connected to each other. Adjacent coil conductors among the plurality of coil conductors include a plurality of second connection portions where the adjacent coil conductors overlap each other and are physically connected to each other. The first connection portion has a path length longer than the shortest path length among path lengths of the plurality of second connection portions.

A Q factor of the multilayer coil component is proportional to a reciprocal of electric resistance. The electric resistance of the coil including the plurality of coil conductors depends on the combined resistance of connection portions where adjacent coil conductors are connected to each other and portions of the adjacent coil conductors not included in the connection portions. The electric resistance of a conductor is proportional to a length of the conductor and inversely proportional to a thickness of the conductor. The connection portion where the adjacent coil conductors overlap each other and are physically connected to each other has a thickness larger than thicknesses of the portions of the adjacent coil conductors not included in the connection portions. Therefore, the connection portion where the adjacent coil conductors overlap each other and are physically connected to each other has electric resistance smaller than electric resistance of the portions of the adjacent coil conductors not included in the connection portions. As a result, the Q factor of the multilayer coil component depends on a path length of the connection portion where the adjacent coil conductors are connected to each other and path lengths of the portions of the adjacent coil conductors not included in the connection portions.

In the multilayer coil component, a plurality of inductance values is obtained for the predetermined outer shape size. Since the inductance value depends on the number of turns of the coil, a path length of each of the plurality of coil conductors including the coil is difficult to be fixed. The path length of each of the plurality of coil conductors is determined so that adjacent coil conductors do not form a loop. The connection portion where the coil conductor having a longer path length than of the other coil conductors is connected to an adjacent coil conductor may have a longer path length than a path length of the connection portion where the other coil conductors are connected to each other.

In another aspect described above, since the first coil conductor is located at the end of the coil, the first coil conductor is adjacent to the second coil conductor only in one orientation in the direction. Since the first coil conductor is not adjacent to a coil conductor in the other orientation, the path length is determined so that a loop is not formed only between the first and second coil conductors. The path length of the second coil conductor is determined so that a loop is not formed both between the first coil conductor and the second coil conductor and between the second coil conductor and a coil conductor to which the second coil conductor is adjacent in an orientation different from an orientation in which the second coil conductor is adjacent to the first coil conductor. Since restriction required for the path length of the first coil conductor is less than restriction required for the path length of the second coil conductor, the path length of the first coil conductor can be extended to be longer than the path length of the second coil conductor. As a result, the first coil conductor has the path length longer than the path length of the second coil conductor.

The first connection portion has a path length longer than the shortest path length among path lengths of the plurality of second connection portions. For example, the shortest second connection portion has the shortest path length among the path lengths of the plurality of second connection portions. Therefore, a path length of a portion of the first coil conductor not included in the first connection portion and a path length of a portion of the second coil conductor not included in the first connection portion are shorter than path lengths of portions of the adjacent coil conductors not included in the shortest second connection portion. As a result, since the combined resistance of the first coil conductor, the first connection portion, the plurality of coil conductors, and the plurality of second connection portions in the one aspect described above is smaller than the combined resistance in a configuration in which the first connection portion has a path length equal to or less than the shortest path length of the second connection portion. Therefore, the one aspect described above makes it possible to improve the Q factor of the multilayer coil component.

The present disclosure will become more fully understood from the detailed description given hereinafter and the accompanying drawings which are given by way of illustration only, and thus are not to be considered as limiting the present disclosure.

Further scope of applicability of the present disclosure will become apparent from the detailed description given hereinafter. However, it should be understood that the detailed description and specific examples, while indicating examples of the disclosure, are given by way of illustration only, since various changes and modifications within the spirit and scope of the disclosure will become apparent to those skilled in the art from this detailed description.

### BRIEF DESCRIPTION OF THE DRAWINGS

FIG. 1 is a perspective view of a multilayer coil component according to an embodiment;

FIG. 2 is a perspective view of a coil according to the present embodiment;

FIG. 3 is a plan view of the coil according to the present embodiment as viewed from a side surface illustrated in FIG. 1;

FIG. 4 is a plan view of the coil according to the present embodiment as viewed from a main surface illustrated in FIG. 1;

FIG. 5 is an exploded view illustrating a configuration of the multilayer coil component according to the present embodiment;

FIG. 6 is a view illustrating adjacent coil conductors;

FIG. 7 is a view illustrating still other adjacent coil conductors;

FIG. 8 is a view illustrating still other adjacent coil conductors;

FIG. 9 is a view illustrating still other adjacent coil conductors;

FIG. 10 is a view illustrating still other adjacent coil conductors;

FIG. 11 is a view illustrating still other adjacent coil conductors; and

FIG. 12 is an exploded view illustrating a configuration of a multilayer coil component according to a modification of the present embodiment.

### DETAILED DESCRIPTION

Hereinafter, examples of the present disclosure will be described in detail with reference to the accompanying drawings. In the following description, the same elements or elements having the same functions are denoted with the same reference numerals and overlapped explanation is omitted.

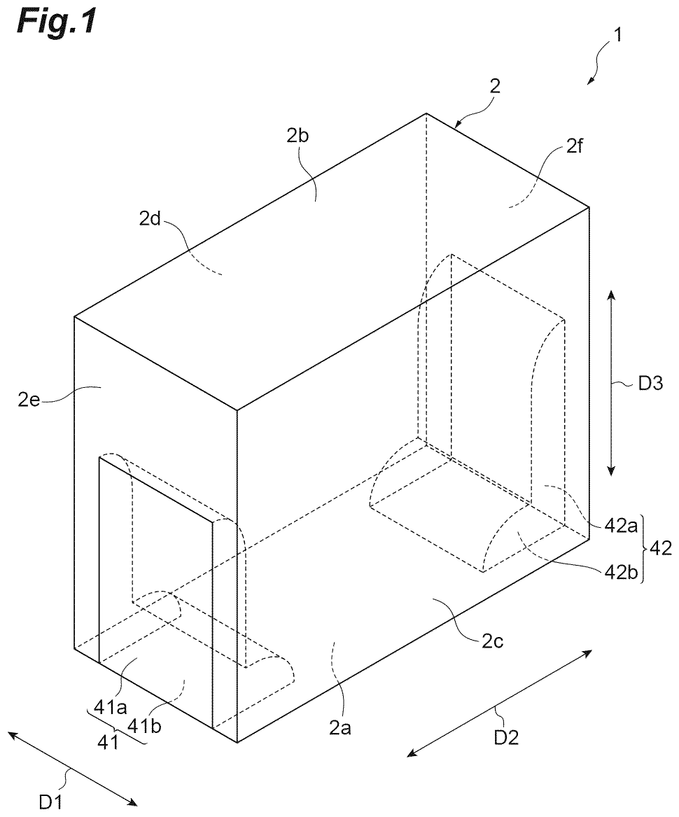

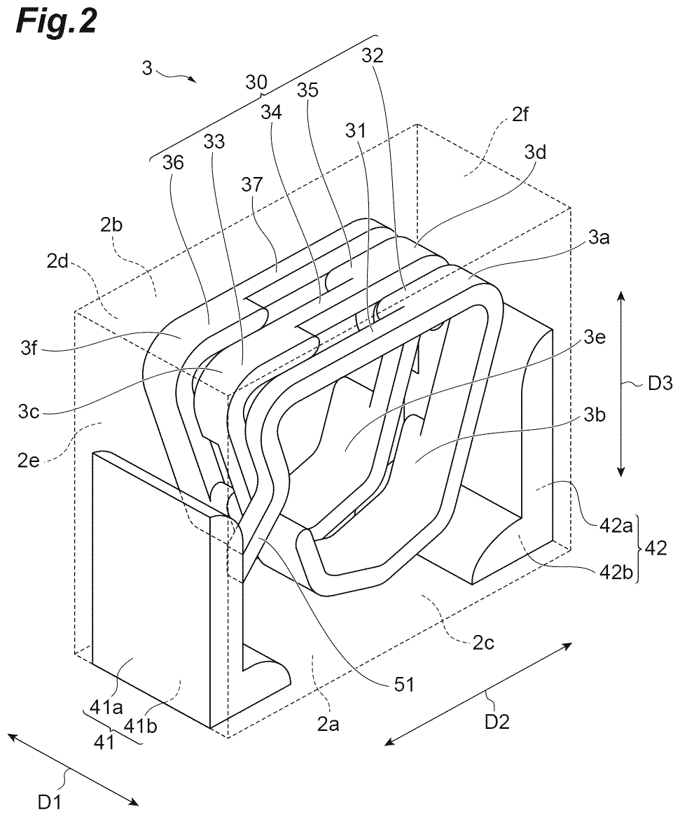

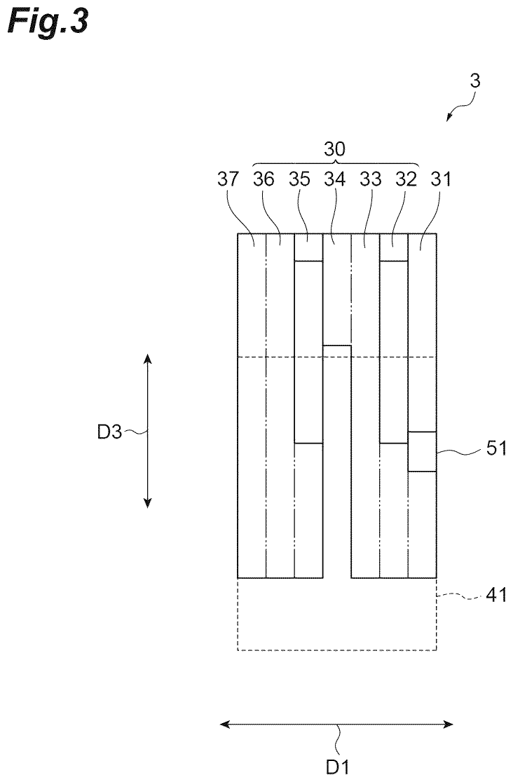

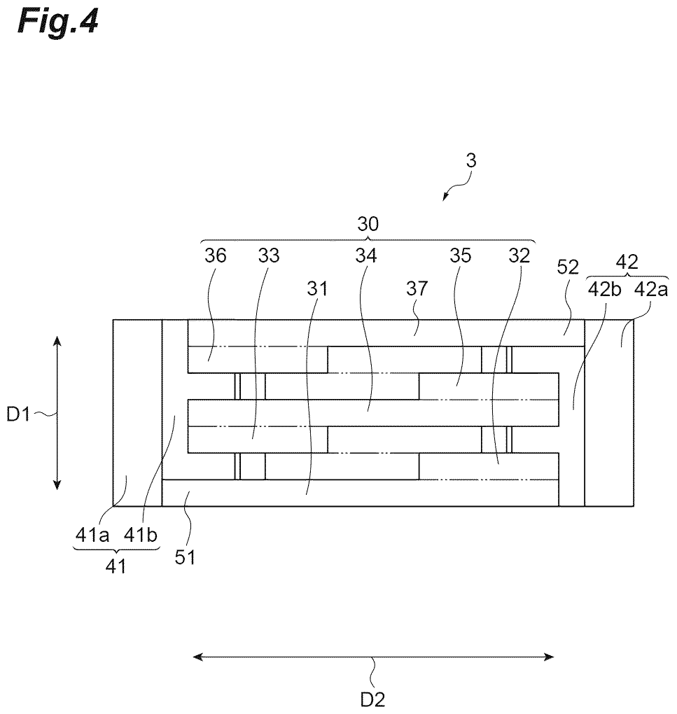

With reference to FIGS. 1 to 4, a configuration of a multilayer coil component 1 according to the present embodiment will be described. FIG. 1 is a perspective view of the multilayer coil component 1 according to the present embodiment. FIG. 2 is a perspective view of a coil 3 according to the present embodiment. FIG. 3 is a plan view of the coil 3 according to the present embodiment as viewed from a side surface 2e illustrated in FIG. 1. FIG. 4 is a plan view of the coil 3 according to the present embodiment as viewed from a main surface 2b illustrated in FIG. 1. The multilayer coil component 1 according to the present embodiment is solder-mounted to an electronic device. The electronic device includes, for example, a circuit board or an electronic component.

As illustrated in FIGS. 1 and 2, the multilayer coil component 1 includes an element body 2, the coil 3 disposed in the element body 2, a pair of external electrodes 41 and 42 disposed on surfaces of the element body 2, and a pair of connection conductors 51 and 52 disposed in the element body 2. The external electrodes 41 and 42 are electrically connected to the coil 3. The element body 2 has a rectangular parallelepiped shape. The rectangular parallelepiped shape includes a rectangular parallelepiped shape in which corner parts and ridge line parts are chamfered, or a rectangular parallelepiped shape in which corner parts and ridge line parts are rounded.

The element body 2 includes a pair of main surfaces 2a and 2b opposing each other, a pair of side surfaces 2c and 2d opposing each other, and a pair of side surfaces 2e and 2f opposing each other. The main surfaces 2a and 2b, the side surfaces 2c and 2d, and the side surfaces 2e and 2f have rectangular shapes. The main surfaces 2a and 2b are adjacent to the side surfaces 2c and 2d and the side surfaces 2e and 2f. The side surfaces 2c and 2d are each adjacent to the side surfaces 2e and 2f. When the multilayer coil component 1 is solder-mounted on the electronic device, the main surface 2a faces the electronic device to be solder-mounted. The main surfaces 2a and 2b, the side surfaces 2c and 2d, and the side surfaces 2e and 2f are flat surfaces. The flat surface means a surface formed so as to be a flat surface and is not limited to a geometrically complete flat surface. The flat surface may include curvature and unevenness that occur in a manufacturing process.

A direction D3 in which the pair of main surfaces 2a and 2b faces each other is orthogonal to each of the main surfaces 2a and 2b. A direction D1 in which the pair of side surfaces 2c and 2d faces each other is orthogonal to each of the side surfaces 2c and 2d. A direction D2 in which the pair of side surfaces 2e and 2f faces each other is orthogonal to each of the side surfaces 2e and 2f. The direction D3 is orthogonal to the direction D1 and the direction D2. The direction D1 and the direction D2 are orthogonal to each other. A pair of recesses corresponding to the pair of external electrodes 41 and 42 is formed in the element body 2.

The external electrodes 41 and 42 have L-shaped cross sections as viewed from the direction D1. The recesses corresponding to the external electrodes 41 and 42 formed in the element body 2 have L shapes as viewed from the direction D1. The external electrode 41 includes a portion 41a and a portion 41b. A surface of the portion 41a is oriented in the same orientation as the side surface 2e, and a surface of the portion 41b is oriented in the same orientation as the main surface 2a. The portion 41a and the portion 41b are continuous along a ridge portion between the side surface 2e and the main surface 2a. The external electrode 42 includes a portion 42a and a portion 42b. A surface of the portion 42a is oriented in the same orientation as the side surface 2f, and a surface of the portion 42b is oriented in the same orientation as the main surface 2a. The portion 42a and the portion 42b are continuous along a ridge portion between the side surface 2f and the main surface 2a.

In the present embodiment, lengths of the external electrodes 41 and 42 in the direction D3 are longer than lengths of the external electrodes 41 and 42 in the direction D2. The portions 41b and 42b are disposed to be exposed in the same orientation as the main surface 2a. Surfaces of the portions 41b and 42b and the main surface 2a may be located on the same flat surface. The surfaces of the portions 41b and 42b may protrude from the main surface 2a. The portion 41a is disposed to be exposed in the same orientation as the side surface 2e. The surface of the portion 41a and the side surface 2e may be located on the same flat surface. The surface of the portion 41a may protrude from the side surface 2e. The portion 42a is disposed on the side surface 2f to be exposed in the same orientation as the side surface 2f. The surface of the portion 42a and the side surface 2f may be located on the same surface. The surface of the portion 42a may protrude from the side surface 2f. In the present embodiment, lengths of the portions 41a and 42a in the direction D3 are longer than lengths of the portions 41b and 42b in the direction D2.

As illustrated in FIGS. 2 to 4, the coil 3 includes coil conductors 31 and 37 and a plurality of coil conductors 30. The coil conductors 31 and 37 and the plurality of coil conductors 30 are electrically connected to each other. The number of turns of the coil 3 is 2.5. The coil conductors 31 and 37 and the respective coil conductors 30 include a part of an annular track of the coil 3. The coil conductors 31 and 37 and the respective coil conductors 30 each have, for example, a shape in which a part of a loop is interrupted. The coil conductors 31 and 37 and the respective coil conductors 30 each have a path length and a thickness.

The coil conductors 31 and 37 are located at ends of the coil 3. In the present embodiment, the coil conductor 31 is located at one end of the coil 3 in the direction D1, and the coil conductor 37 is located at the other end of the coil 3 in the direction D1. The coil conductor 31 is included in the same layer as the connection conductor 51, and the coil conductor 37 is included in the same layer as the connection conductor 52. The plurality of coil conductors 30 is arranged in the direction D1. The plurality of coil conductors 30 includes coil conductors 32,33,34,35, and 36 arranged in this order (the conductor 32, the conductor 33, the conductor 34, the conductor 35, and the conductor 36) along the direction D1. The coil conductor 32 is adjacent to the coil conductor 31 in the direction D1, and the coil conductor 36 is adjacent to the coil conductor 37 in the direction D1. The coil conductors 32 and 36 are adjacent to the coil conductors 31 and 37 in the direction D1, respectively. The coil conductors 31 and 37 include first coil conductors. The coil conductors 32 and 36 include second coil conductors.

Widths of the coil conductors 31 and 37 and the respective coil conductors 30 in a direction orthogonal to paths of the coil conductors 31 and 37 and the respective coil conductors 30 are equal to each other. Thicknesses of the coil conductors 31 and 37 and the respective coil conductors 30 are equal to each other. In the present specification, the term “equal” does not necessarily mean that values coincide with each other. Even in a case where values include slight differences, manufacturing errors, or measurement errors within a preset range, the values may be regarded as being equal to each other. Each layer of the coil conductors 31 and 37 and the respective coil conductors 32 to 36 corresponds to each layer including the multilayer coil component 1. Each layer of the coil conductors 31 and 37 and the respective coil conductors 32 to 36 extend along a flat surface intersecting the direction D1 in which the coil conductors 31 and 37 and the respective coil conductors 32 to 36 are arranged. In the present embodiment, each layer of the coil conductors 31 and 37 and the respective coil conductors 32 to 36 extend along the direction D2 and the direction D3.

The coil conductors 31 and 37 and the respective coil conductors 32 to 36 each include a first end and a second end. The first end corresponds to one end in the shape in which the part of the loop is interrupted. The second end corresponds to the other end in the shape in which the part of the loop is interrupted. The coil conductors 31 and 37 and the respective coil conductors 32 to 36 extend along paths from the first ends to the second ends in respective layers of the coil conductors 31 and 37 and the respective coil conductors 32 to 36. Lengths of the paths from the first ends to the second ends of the coil conductors 31 and 37 and the respective coil conductors 32 to 36 are referred to as path lengths of the coil conductors 31 and 37 and the respective coil conductors 32 to 36, respectively.

The connection conductor 51 electrically connects the coil 3 and the external electrode 41 to each other. The coil 3 and the external electrode 41 are physically connected to each other via the connection conductor 51. The connection conductor 51 is continuous with the coil conductor 31 in the same layer as the coil conductor 31. The connection conductor 51 extends between the first end of the coil conductor 31 and the portion 41a of the external electrode 41. A thickness of the connection conductor 51 is equal to the thickness of the coil conductor 31. The connection conductor 52 electrically connects the coil 3 and the external electrode 42 to each other. The coil 3 and the external electrode 42 are physically connected to each other via the connection conductor 52. The connection conductor 52 is continuous with the coil conductor 37 in the same layer as the coil conductor 37. The connection conductor 52 extends between the second end of the coil conductor 37 and the portion 42a of the external electrode 42. A thickness of the connection conductor 52 is equal to the thickness of the coil conductor 37. Respective thicknesses of the connection conductor 51 and the connection conductor 52 are equal to each other.

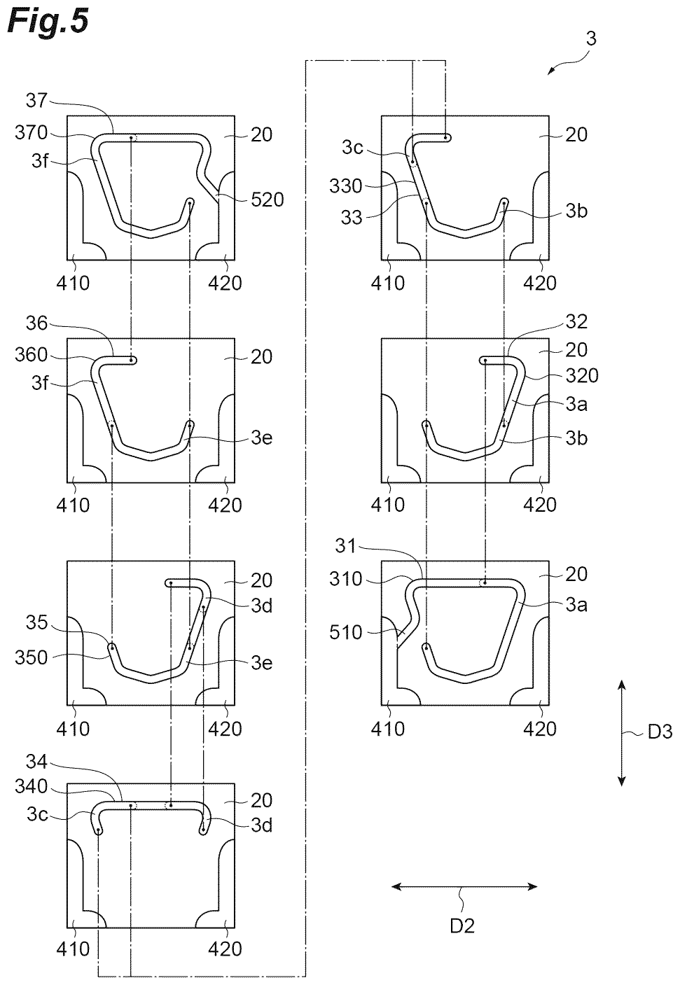

FIG. 5 is an exploded view illustrating a configuration of the multilayer coil component 1 according to the present embodiment. In the present embodiment, a laminating direction of the multilayer coil component 1 is along the direction D1. FIG. 5 illustrates a plurality of layers including the multilayer coil component 1 as viewed from the direction D1. The plurality of layers including the multilayer coil component 1 includes a layer including the element body 2, a layer including the coil 3, layers including the external electrodes 41 and 42, and layers including the connection conductors 51 and 52. Thicknesses of the plurality of layers are equal to each other. Hereinafter, with reference to FIG. 5, the element body 2, the coil 3, the external electrodes 41 and 42, and the connection conductors 51 and 52 will be described.

The element body 2 includes a plurality of stacked insulator layers 20. In the present embodiment, the number of the plurality of insulator layers 20 is “9”. FIG. 5 illustrates seven insulator layers 20 while one insulator layer 20 located at each end in the direction D1 is omitted. In the actual element body 2, the respective insulator layers 20 are integrated to such an extent that boundaries between the insulator layers 20 cannot be visually recognized. Each of the insulator layers 20 includes, for example, a nonmagnetic material. The nonmagnetic material includes, for example, a glass ceramic material or a dielectric material. In the present embodiment, each insulator layer 20 includes a sintered body of a green sheet including a nonmagnetic material. Each of the insulator layers 20 may include, for example, a magnetic material.

The external electrode 41 and the external electrode 42 includes a plurality of stacked electrode layers 410 and a plurality of stacked electrode layers 420, respectively. In the present embodiment, the number of the plurality of electrode layers 410 and the number of the plurality of electrode layers 420 are each “7”. In the actual external electrode 41, the respective electrode layers 410 are integrated to such an extent that boundaries between the electrode layers 410 cannot be visually recognized. In the actual external electrode 42, the respective electrode layers 420 are integrated to such an extent that boundaries between the electrode layers 420 cannot be visually recognized. Each of the electrode layers 410 and 420 is provided in a defective portion formed in the corresponding insulator layers 20. A pair of recesses corresponding to the external electrodes 41 and 42 is obtained by the defective portions formed in the respective insulator layers 20. Each of the electrode layers 410 and 420 includes, for example, a conductive material. The conductive material includes, for example, Ag or Pd. In the present embodiment, each of the electrode layers 410 and 420 includes a sintered body of a conductive paste including powder of the conductive material.

The connection conductor 51 and the connection conductor 52 includes an electrode layer 510 and an electrode layer 520, respectively. The electrode layer 510 is continuous with a coil conductor layer 310, and the electrode layer 520 is continuous with a coil conductor layer 370. Each of the electrode layers 510 and 520 is provided in a defective portion formed in the corresponding insulator layer 20. Each of the electrode layer 510 and 520 includes, for example, the same material as that of each of the electrode layers 410 and 420. Each of the electrode layers 510 and 520 includes, for example, a sintered body of a conductive paste.

The coil 3 includes a plurality of coil conductor layers. The coil conductor 31 includes the coil conductor layer 310. The coil conductor 32 includes a coil conductor layer 320. The coil conductor 33 includes a coil conductor layer 330. The coil conductor 34 includes a coil conductor layer 340. The coil conductor 35 includes a coil conductor layer 350. The coil conductor 36 includes a coil conductor layer 360. The coil conductor 37 includes the coil conductor layer 370. Each of the coil conductor layers 310 to 370 is provided in a defective portion formed in the corresponding insulator layer 20. Each of the coil conductor layers 310 to 370 includes, for example, the same material as that of each of the electrode layers 410 and 420. Each of the coil conductor layers 310 to 370 includes, for example, a sintered body of a conductive paste.

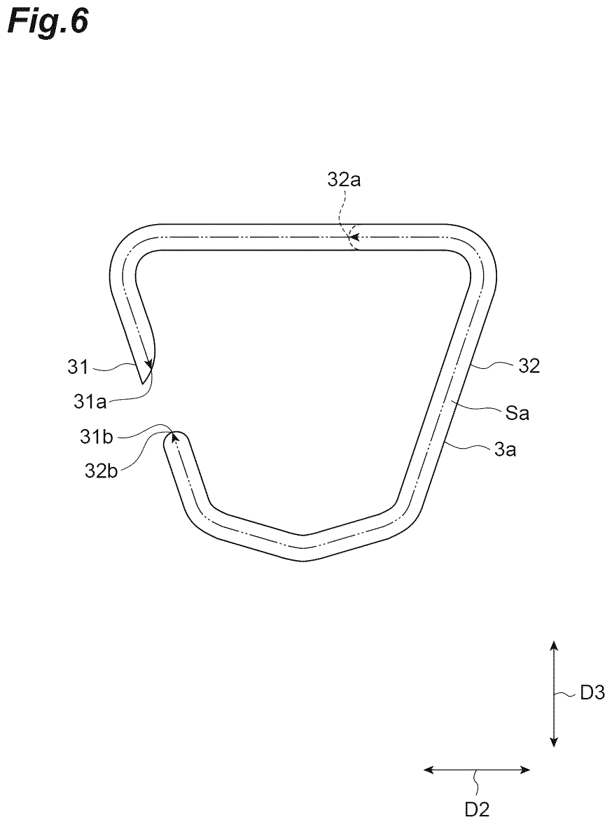

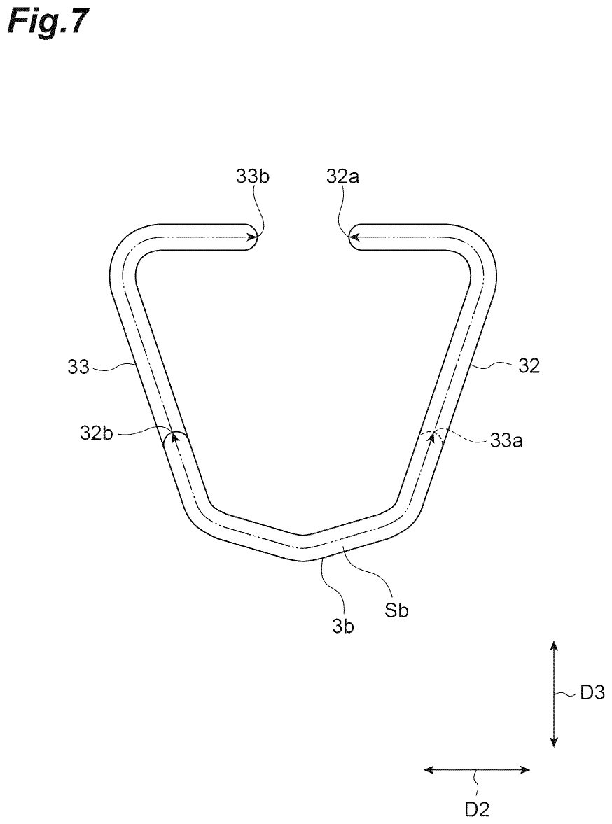

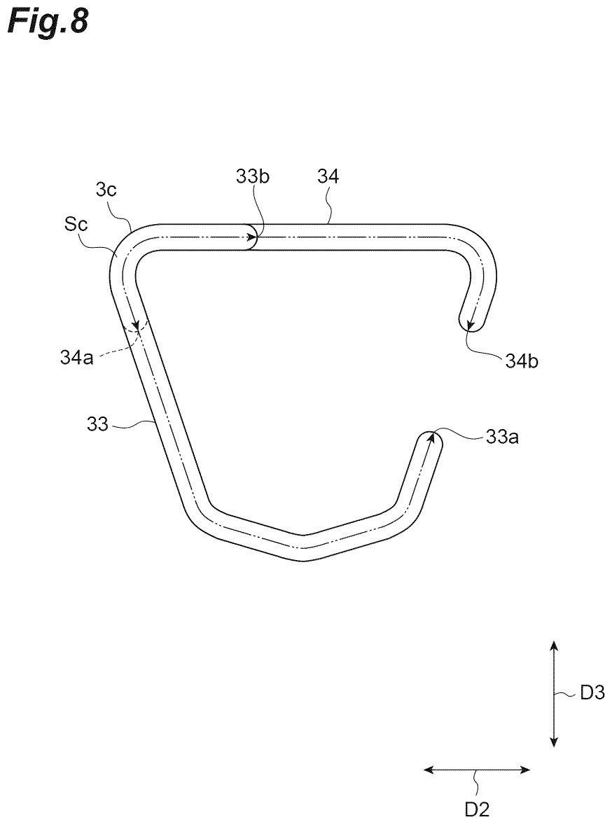

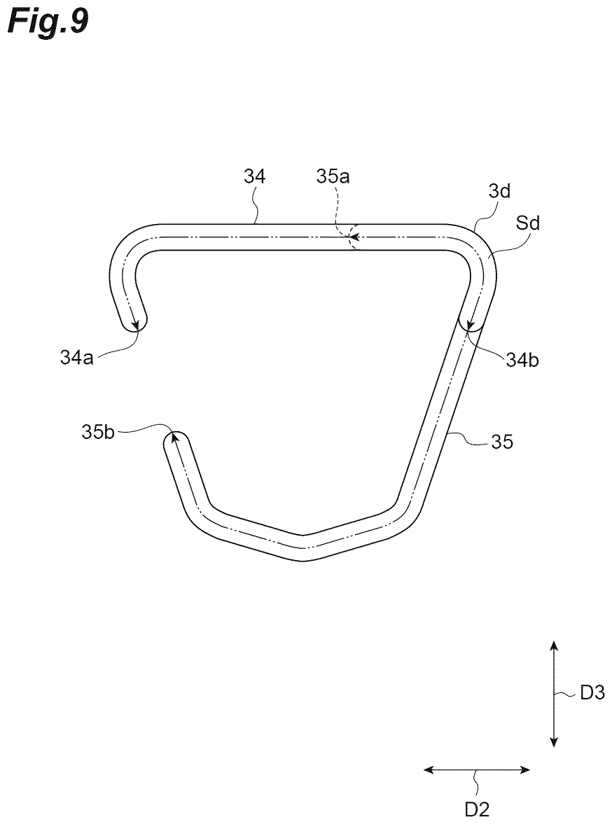

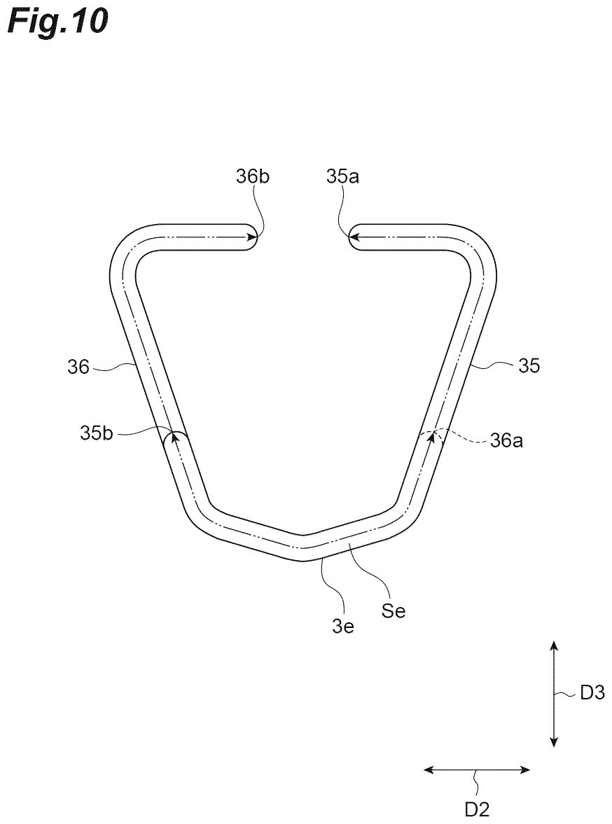

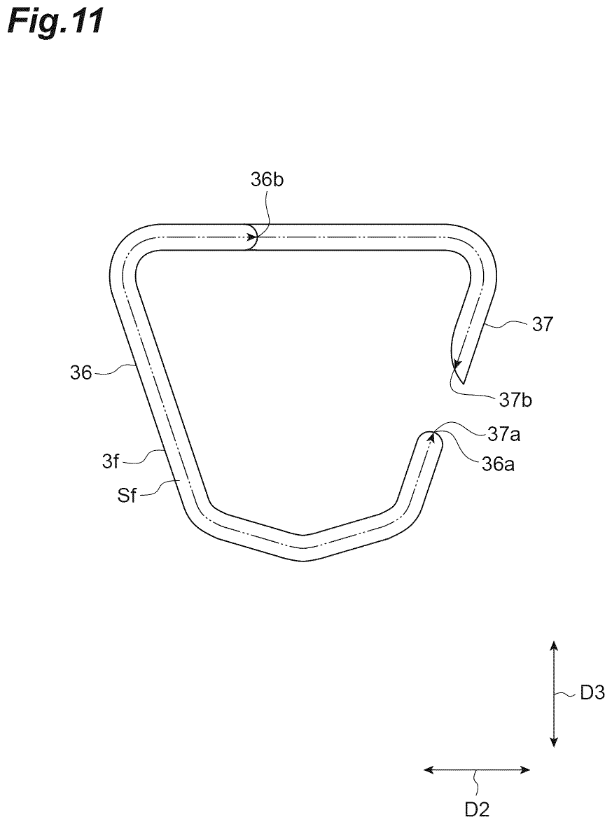

Hereinafter, with reference to FIGS. 2 and 5 to 11, the coil 3 will be described. As illustrated in FIG. 5, the coil conductor layer 310, the coil conductor layers 320 to 360, and the coil conductor layer 370 correspond to the coil conductor 31, the coil conductors 32 to 36, and the coil conductor 37 as viewed from the direction D1, respectively. FIG. 6 is a view illustrating the adjacent coil conductors 31 and 32. FIG. 7 is a view illustrating the adjacent coil conductors 32 and 33. FIG. 8 is a view illustrating the adjacent coil conductors 33 and 34. FIG. 9 is a view illustrating the adjacent coil conductors 34 and 35. FIG. 10 is a view illustrating the adjacent coil conductors 35 and 36. FIG. 11 is a view illustrating the adjacent coil conductors 36 and 37.

As viewed from the direction D1, the coil 3 has a pentagonal shape. The pentagon is line-symmetric in the direction D2 relative to a center line along the direction D3. The pentagon includes a first side located closest to the main surface 2b, a second side located closest to the side surface 2f, a third side and a fourth side located closest to the main surface 2a, and a fifth side located closest to the side surface 2e. The first side and the second side are connected at a first vertex, the second side and the third side are connected at a second vertex, the third side and the fourth side are connected at a third vertex, the fourth side and the fifth side are connected at a fourth vertex, and the fifth side and the first side are connected at a fifth vertex. With respect to a center line passing through the third vertex between the third side and the fourth side, the second side and the fifth side are line-symmetric with each other, and the third side and the fourth side are line-symmetric with each other. The first side is longer than each of the second side and the fifth side. Each of the second side and the fifth side is longer than each of the third side and the fourth side.

As illustrated in FIG. 6, the path of the coil conductor 31 includes a part of the fifth side, the first side, the second side, the third side, the fourth side, and another part of the fifth side. The coil conductor 31 extends along the path from an end 31a to an end 31b. The path of the coil conductor 31 is illustrated by a dash-dot-dot line connecting the end 31a and the end 31b. The path length of the coil conductor 31 is a ½ turn or more. The path of the coil conductor 32 includes a part of the first side, the second side, the third side, the fourth side, and a part of the fifth side. The coil conductor 32 extends along the path from an end 32a to an end 32b. The path of the coil conductor 32 is illustrated by a dash-dot-dot line connecting the end 32a and the end 32b. The path length of the coil conductor 32 is a ½ turn or more.

The coil conductor 31 and the coil conductor 32 are adjacent to each other in the direction D1. The coil conductor 31 and the coil conductor 32 include a connection portion 3a where the coil conductor 31 and the coil conductor 32 overlap each other and are physically connected to each other. In the connection portion 3a, a portion including the end 31b of the coil conductor 31 and a portion including the end 32a of the coil conductor 32 overlap each other in the direction D1. In the present embodiment, in the connection portion 3a, a portion including the end 31b of the coil conductor 31 and the entire coil conductor 32 overlap each other in the direction D1. In one example, in the connection portion 3a, the end 31b of the coil conductor 31 and the end 32b of the coil conductor 32 overlap each other in the direction D1. The connection portion 3a includes the entire coil conductor 32. An area of the connection portion 3a as viewed from the direction D1 includes an area Sa.

A path of the connection portion 3a includes a part of the first side, the second side, the third side, the fourth side, and a part of the fifth side. The path of the connection portion 3a is the same as the path of the coil conductor 32. The path of the connection portion 3a is illustrated by a dash-dot-dot line connecting the end 32a and the end 31b. As viewed from the direction D1, the connection portion 3a is curved between the first side and the second side, between the second side and the third side, between the third side and the fourth side, and between the fourth side and the fifth side. The connection portion 3a includes a first connection portion.

As illustrated in FIG. 7, the path of the coil conductor 33 includes a part of the second side, the third side, the fourth side, the fifth side, and a part of the first side. The coil conductor 33 extends along the path from an end 33a to an end 33b. The path of the coil conductor 33 is illustrated by a dash-dot-dot line connecting the end 33a and the end 33b. The path length of the coil conductor 33 is a ½ turn or more.

The coil conductor 32 and the coil conductor 33 are adjacent to each other in the direction D1. The coil conductor 32 and the coil conductor 33 include a connection portion 3b where the coil conductor 32 and the coil conductor 33 overlap each other and are physically connected to each other. In the connection portion 3b, a portion including the end 32b of the coil conductor 32 and a portion including the end 33a of the coil conductor 33 overlap each other in the direction D1. An area of the connection portion 3b as viewed from the direction D1 includes an area Sb.

A path of the connection portion 3b includes a part of the second side, the third side, the fourth side, and a part of the fifth side. The path of the connection portion 3b is illustrated by a dash-dot-dot line connecting the end 33a and the end 32b. As viewed from the direction D1, the connection portion 3b is curved between the second side and the third side, between the third side and the fourth side, and between the fourth side and the fifth side. The connection portion 3b includes a second connection portion.

As illustrated in FIG. 8, the path of the coil conductor 34 includes a part of the fifth side, the first side, and a part of the second side. The coil conductor 34 extends along the path from an end 34a to an end 34b. The path of the coil conductor 34 is illustrated by a dash-dot-dot line connecting the end 34a and the end 34b. The path length of the coil conductor 34 is a ½ turn or less.

The coil conductor 33 and the coil conductor 34 are adjacent to each other in the direction D1. The coil conductor 33 and the coil conductor 34 include a connection portion 3c where the coil conductor 33 and the coil conductor 34 overlap each other and are physically connected to each other. In the connection portion 3c, a portion including the end 33b of the coil conductor 33 and a portion including the end 34a of the coil conductor 34 overlap each other in the direction D1. An area of the connection portion 3c as viewed from the direction D1 includes an area Sc.

A path of the connection portion 3c includes a part of the fifth side and a part of the first side. The path of the connection portion 3c is illustrated by a dash-dot-dot line connecting the end 34a and the end 33b. As viewed from the direction D1, the connection portion 3c is curved between the fifth side and the first side. The connection portion 3c includes a second connection portion.

As illustrated in FIG. 9, the path of the coil conductor 35 includes a part of the first side, the second side, the third side, the fourth side, and a part of the fifth side. The coil conductor 35 extends along the path from an end 35a to an end 35b. The path of the coil conductor 35 is illustrated by a dash-dot-dot line connecting the end 35a and the end 35b. The path length of the coil conductor 35 is a ½ turn or more. The coil conductor 35 and the coil conductor 32 have the same shape.

The coil conductor 34 and the coil conductor 35 are adjacent to each other in the direction D1. The coil conductor 34 and the coil conductor 35 include a connection portion 3d where the coil conductor 34 and the coil conductor 35 overlap each other and are physically connected to each other. In the connection portion 3d, a portion including the end 34b of the coil conductor 34 and a portion including the end 35a of the coil conductor 35 overlap each other in the direction D1. An area of the connection portion 3d as viewed from the direction D1 includes an area Sd.

A path of the connection portion 3d includes a part of the first side and a part of the second side. The path of the connection portion 3d is illustrated by a dash-dot-dot line connecting the end 35a and the end 34b. As viewed from the direction D1, the connection portion 3d is curved between the first side and the second side. The connection portion 3d includes a second connection portion.

As illustrated in FIG. 10, the path of the coil conductor 36 includes a part of the second side, the third side, the fourth side, the fifth side, and a part of the first side. The coil conductor 36 extends along the path from an end 36a to an end 36b. The path of the coil conductor 36 is illustrated by a dash-dot-dot line connecting the end 36a and the end 36b. The path length of the coil conductor 36 is a ½ turn or more. The coil conductor 36 and the coil conductor 33 have the same shape.

The coil conductor 35 and the coil conductor 36 are adjacent to each other in the direction D1. The coil conductor 35 and the coil conductor 36 include a connection portion 3e where the coil conductor 35 and the coil conductor 36 overlap each other and are physically connected to each other. In the connection portion 3e, a portion including the end 35b of the coil conductor 35 and a portion including the end 36a of the coil conductor 36 overlap each other in the direction D1. An area of the connection portion 3e as viewed from the direction D1 includes an area Se. The connection portion 3e and the connection portion 3b have the same shape.

A path of the connection portion 3e includes a part of the second side, the third side, the fourth side, and a part of the fifth side. The path of the connection portion 3e is illustrated by a dash-dot-dot line connecting the end 36a and the end 35b. As viewed from the direction D1, the connection portion 3e is curved between the second side and the third side, between the third side and the fourth side, and between the fourth side and the fifth side. The connection portion 3e includes a second connection portion.

As illustrated in FIG. 11, the path of the coil conductor 37 includes a part of the second side, the third side, the fourth side, the fifth side, the first side, and another part of the second side. The coil conductor 37 extends along the path from an end 37a to an end 37b. The path of the coil conductor 37 is illustrated by a dash-dot-dot line connecting the end 37a and the end 37b. The path length of the coil conductor 31 is a ½ turn or more.

The coil conductor 36 and the coil conductor 37 are adjacent to each other in the direction D1. The coil conductor 36 and the coil conductor 37 include a connection portion 3f where the coil conductor 36 and the coil conductor 37 overlap each other and are physically connected to each other. In the connection portion 3f, a portion including the end 36b of the coil conductor 36 and a portion including the end 37a of the coil conductor 37 overlap each other in the direction D1. In the present embodiment, in the connection portion 3f, a portion including the end 37a of the coil conductor 37 and the entire coil conductor 36 overlap each other in the direction D1. In one example, in the connection portion 3f, the end 36a of the coil conductor 36 and the end 37a of the coil conductor 37 overlap each other in the direction D1. The connection portion 3f includes the entire coil conductor 36. An area of the connection portion 3f as viewed from the direction D1 includes an area Sf.

A path of the connection portion 3f includes a part of the second side, the third side, the fourth side, the fifth side, and a part of the first side. The path of the connection portion 3f is the same as the path of the coil conductor 36. The path of the connection portion 3f is illustrated by a dash-dot-dot line connecting the end 37a and the end 36b. As viewed from the direction D1, the connection portion 3f is curved between the second side and the third side, between the third side and the fourth side, between the fourth side and the fifth side, and between the fifth side and the first side. The connection portion 3f includes a first connection portion.

As described above, the connection portions 3a and 3f include first connection portions, and the connection portions 3b, 3c, 3d, and 3e include a plurality of second connection portions. In the present specification, the term “overlap” is not limited to a configuration in which outer shapes of portions overlapping each other coincide with each other. The portions including the end 31b of the coil conductor 31, the end 32b of the coil conductor 32, the end 33b of the coil conductor 33, the end 34b of the coil conductor 34, the end 35b of the coil conductor 35, the end 36b of the coil conductor 36 and the portions including the end 32a of the coil conductor 32, the end 33a of the coil conductor 33, the end 34a of the coil conductor 34, the end 35a of the coil conductor 35, the end 36a of the coil conductor 36, the end 37a of the coil conductor 37 may include portions that do not overlap in the direction D1. The portions including the end 31b of the coil conductor 31, the end 32b of the coil conductor 32, the end 33b of the coil conductor 33, the end 34b of the coil conductor 34, the end 35b of the coil conductor 35, the end 36b of the coil conductor 36 and the portions including the end 32a of the coil conductor 32, the end 33a of the coil conductor 33, the end 34a of the coil conductor 34, the end 35a of the coil conductor 35, the end 36a of the coil conductor 36, the end 37a of the coil conductor 37 may include portions not included in the connection portions 3a to 3f.

The area Sa of the connection portion 3a and the area Sf of the connection portion 3f may be equal to each other. The area Sb of the connection portion 3b and the area Se of the connection portion 3e may be equal to each other. The area Sc of the connection portion 3c and the area Sd of the connection portion 3d may be equal to each other. The areas Sc and Sd are the smallest among the areas Sb, Sc, Sd, and Se. The areas Sa and Sf are larger than the areas Sc and Sd. The areas Sa and Sf are larger than any of the areas Sb, Sc, Sd, and Se.

The path lengths of the connection portions 3a and 3f may be equal to each other. The path lengths of the connection portions 3b and 3e may be equal to each other. The path lengths of the connection portions 3c and 3d may be equal to each other. The path lengths of the connection portions 3c and 3d are the smallest among the path lengths of the connection portions 3b, 3c, 3d, and 3e. The path lengths of the connection portions 3a and 3f are larger than the path lengths of the connection portions 3c and 3d. The path lengths of the connection portions 3a and 3f are larger than any of the path lengths of the connection portions 3b, 3c, 3d, and 3e.

As described above, since in the multilayer coil component 1, the coil conductors 31 and 37 are located at the ends of the coil 3, the coil conductors 31 and 37 are adjacent to coil conductors only in one orientation in the direction D1. Since the coil conductor 31 is not adjacent to a coil conductor in the other orientation, the path length is determined so that a loop is not formed only between the coil conductors 31 and 32. Since the coil conductor 37 is not adjacent to a coil conductor in the other orientation, the path length is determined so that a loop is not formed only between the coil conductors 36 and 37. The path length of the coil conductor 32 is determined so that a loop is not formed both between the coil conductors 31 and 32 and between the coil conductors 32 and 33. The path length of the coil conductor 36 is determined so that a loop is not formed both between the coil conductors 36 and 37 and between the coil conductors 35 and 36. Since limitations required for the path lengths of the coil conductors 31 and 37 are fewer than limitations required for the path lengths of the coil conductors 32 and 36, the path lengths of the coil conductors 32 and 36 can be extended to be longer than the path lengths of the coil conductors 31 and 37. As a result, the coil conductors 31 and 37 have path lengths longer than the path lengths of the coil conductors 32 and 36, respectively.

The area Sa of the connection portion 3a and the area Sf of the connection portion 3f are larger than the smallest areas Sc and Sd among the areas Sb, Sc, Sd, and Se that are areas of a plurality of connection portions 3b, 3c, 3d, and 3e, respectively. Therefore, the electric resistance of the connection portions 3a and 3f is smaller than the electric resistance of the connection portions 3c and 3d having the smallest area. As a result, since the combined resistance of the coil conductors 31 and 37, the connection portions 3a and 3f, the plurality of coil conductors 30, and the plurality of connection portions 3b, 3c, 3d, and 3e in the one aspect described above is smaller than combined resistance in a configuration in which the connection portions 3a and 3f have areas equal to or less than the areas of the connection portions 3c and 3d, respectively. Therefore, the multilayer coil component 1 makes it possible to improv the Q factor of the multilayer coil component.

In the multilayer coil component 1, the areas of the connection portions 3a and 3f as viewed from the direction D1 are larger than any of areas of the plurality of connection portions 3b, 3c, 3d, and 3e viewed from the direction.

In a configuration in which the connection portions 3a and 3f have areas larger than an area of any of the plurality of connection portions 3b, 3c, 3d, and 3e, the electric resistance of the connection portions 3a and 3f is smaller than electric resistance of any of the plurality of connection portions 3b, 3c, 3d, and 3e. Therefore, the multilayer coil component 1 makes it possible to further improve the Q factor of the multilayer coil component.

Since in the multilayer coil component 1, the coil conductors 31 and 37 are located at the ends of the coil 3, the coil conductors 31 and 37 are adjacent to coil conductors only in one orientation in the direction D1. Since the coil conductor 31 is not adjacent to a coil conductor in the other orientation, the path length is determined so that a loop is not formed only between the coil conductors 31 and 32. Since the coil conductor 37 is not adjacent to a coil conductor in the other orientation, the path length is determined so that a loop is not formed only between the coil conductors 36 and 37. The path length of the coil conductor 32 is determined so that a loop is not formed both between the coil conductors 31 and 32 and between the coil conductors 32 and 33. The path length of the coil conductor 36 is determined so that a loop is not formed both between the coil conductors 36 and 37 and between the coil conductors 35 and 36. Since limitations required for the path lengths of the coil conductors 31 and 37 are fewer than limitations required for the path lengths of the coil conductors 32 and 36, the path lengths of the coil conductors 32 and 36 can be extended to be longer than the path lengths of the coil conductors 31 and 37. As a result, the coil conductors 31 and 37 have path lengths longer than the path lengths of the coil conductors 32 and 36, respectively.

The connection portions 3a and 3f have path lengths longer than the shortest path length among the path lengths of the plurality of connection portions 3b, 3c, 3d, and 3e. In the multilayer coil component 1, the connection portions 3c and 3d each have the shortest path length among the plurality of connection portions 3b, 3c, 3d, and 3e. Therefore, the path lengths of the portions of the coil conductors 31 and 37 not included in the connection portions 3a and 3f, respectively and the path lengths of the portions of the coil conductors 32 and 36 not included in the connection portions 3a and 3f, respectively are shorter than the path lengths of portions of the adjacent coil conductors 33, 34 and 35 not included in the connection portions 3c and 3d. As a result, since the combined resistance of the coil conductors 31 and 37, the connection portions 3a and 3f, the plurality of coil conductors 30, and the plurality of connection portions 3b, 3c, 3d, and 3e in the one aspect is smaller than combined resistance in a configuration in which the connection portions 3a and 3f have path lengths equal to or less than the path lengths of the connection portions 3c and 3d. Therefore, the multilayer coil component 1 can improve the Q factor of the multilayer coil component.

The path lengths of the connection portions 3a and 3f are longer than any of the path lengths of the plurality of connection portions 3b, 3c, 3d, and 3e.

In a configuration in which the connection portions 3a and 3f have path lengths longer than any of the path lengths of the plurality of connection portions 3b, 3c, 3d, and 3e, the path lengths of the portions of the coil conductors 31 and 37 not included in the connection portions 3a and 3f, respectively and the path lengths of the portions of the coil conductors 32 and 36 not included in the connection portions 3a and 3f, respectively are shorter than any of path lengths of portions of the adjacent coil conductors not included in the connection portions 3b, 3c, 3d, and 3e, the adjacent coil conductors being the plurality of coil conductors 30. Therefore, the multilayer coil component 1 makes it possible to further improve the Q factor.

The coil conductors 31 and 37 have path lengths longer than any of path lengths of the plurality of coil conductors 30.

A configuration in which the path lengths of the coil conductors 31 and 37 are longer than any of the path lengths of the plurality of coil conductors 30 tends to reliably maintain the areas of the connection portions 3a and 3f and to maintain the path lengths of the connection portions 3a and 3f.

The connection portion 3a includes the entire coil conductor 32, and the connection portion 3f includes the entire coil conductor 36.

A configuration in which the connection portions 3a and 3f include the entire coil conductors 32 and 36, respectively tends to reliably maintain the areas of the connection portions 3a and 3f and to maintain the path lengths of the connection portions 3a and 3f.

The connection portions 3a and 3f are curved as viewed from the direction D1.

Since impedance becomes discontinuous in a curved portion of a coil conductor, a loss due to reflection of a high-frequency current may occur in the curved portion of the coil conductor. In a configuration in which the connection portions 3a and 3f are curved as viewed from the direction D1, a loss tends to be low since the connection portions 3a and 3f have thicknesses in the direction D1 as compared with a configuration in which a coil conductor is curved as viewed from the direction D1.

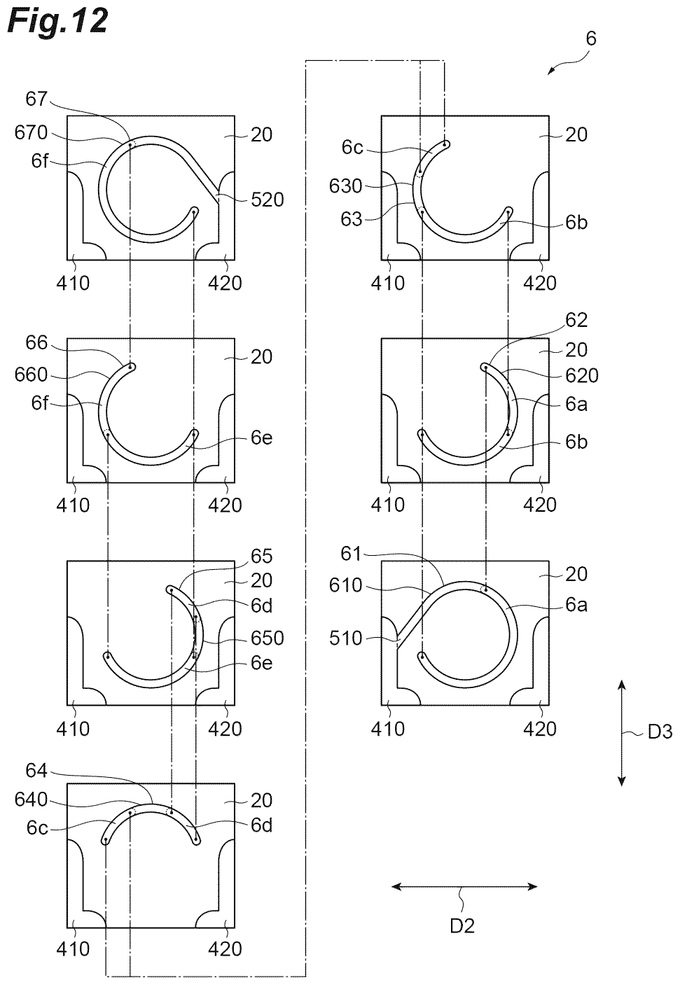

FIG. 12 is an exploded view illustrating a configuration of a multilayer coil component according to a modification of the present embodiment. The multilayer coil component according to the modification includes a coil 6 instead of the coil 3. Hereinafter, with reference to FIG. 12, the coil 6 will be described. Hereinafter, differences between the embodiment described above and the present modification will be mainly described. The coil 6 includes coil conductors 61 and 67 and a plurality of coil conductors 62 to 66. As illustrated in FIG. 12, a coil conductor layer 610, coil conductor layers 620 to 660, and a coil conductor layer 670 correspond to the coil conductor 61, the coil conductors 62 to 66, and the coil conductor 67 as viewed from a direction D1, respectively.

As viewed from the direction D1, the coil 6 has a circular shape. The number of turns of the coil 6 is 2.5. The coil conductors 61 and 67 and the respective coil conductors 62 to 66 include a part of an annular track of the coil 6. The coil conductors 61 and 67 and the respective coil conductors 62 to 66 have, for example, arc shapes. The coil conductors 61 and 67 and the respective coil conductors 62 to 66 have thicknesses equal to each other.

The coil conductors 61 and 67 are located at ends of the coil 6. The coil conductor 61 is located at one end of the coil 6 in the direction D1, and the coil conductor 67 is located at the other end of the coil 6 in the direction D1. The coil conductor 61 is included in the same layer as a connection conductor 51, and the coil conductor 67 is included in the same layer as a connection conductor 52. The plurality of coil conductors 62, 63, 64, 65, and 66 is arranged in this order (the conductor 62, the conductor 63, the conductor 64, the conductor 65, and the conductor 66) along the direction D1. The coil conductor 62 is adjacent to the coil conductor 61 in the direction D1, and the coil conductor 66 is adjacent to the coil conductor 67 in the direction D1.

Path lengths of the coil conductors 61 to 63 are each a ½ turn or more. A path length of the coil conductor 64 is a ½ turn or less. Path lengths of the coil conductors 65 and 67 are each a ½ turn or more. The path lengths of the coil conductors 61 and 67 may be equal to each other. The path lengths of the coil conductors 62, 66, 65, and 66 may be equal to each other. The coil conductor 61 has a path length longer than that of the coil conductor 62. The coil conductor 67 has a path length longer than that of the coil conductor 66. The coil conductors 61 and 67 have path lengths longer than any of the path lengths of the plurality of coil conductors 62 to 66. The coil conductor 64 has the shortest path length among the path lengths of the plurality of coil conductors 62 to 66.

As illustrated in FIG. 12, the coil 6 includes connection portions 6a, 6b, 6c, 6d, 6e, and 6f. As viewed from the direction D1, the connection portions 6a, 6b, 6c, 6d, 6e, and 6f are curved. As viewed from the direction D1, the connection portions 6a, 6b, 6c, 6d, 6e, and 6f have, for example, arc shapes.

In the connection portion 6a, the coil conductor 61 and the coil conductor 62 overlap each other and are physically connected to each other. The connection portion 6a includes the entire coil conductor 62.

In the connection portion 6b, the adjacent coil conductors 62 and 63 overlap each other and are physically connected to each other. In the connection portion 6c, the adjacent coil conductors 63 and 64 overlap each other and are physically connected to each other. In the connection portion 6d, the adjacent coil conductors 64 and 65 overlap each other and are physically connected to each other. In the connection portion 6e, the adjacent coil conductors 65 and 66 overlap each other and are physically connected to each other.

In the connection portion 6f, the coil conductor 66 and the coil conductor 67 each other and are physically connected to each other. The connection portion of includes the entire coil conductor 66.

The connection portions 6a and 6f include first connection portions, and the connection portions 6b, 6c, 6d, and 6e include a plurality of second connection portions.

Areas of the connection portions 6a and of may be equal to each other. Areas of the connection portions 6b and 6e may be equal to each other. Areas of the connection portions 6c and 6d may be equal to each other. The areas of the connection portions 6c and 6d are the smallest among the areas of the connection portions 6b, 6c, 6d, and 6e. The areas of the connection portions 6a and 6f are larger than the areas of the connection portions 6c and 6d. The areas of the connection portions 6a and 6f are larger than any of the areas of the connection portions 6b, 6c, 6d, and 6e.

Path lengths of the connection portions 6a and of may be equal to each other. Path lengths of the connection portions 6b and 6e may be equal to each other. Path lengths of the connection portions 6c and 6d may be equal to each other. The path lengths of the connection portions 6c and 6d are the smallest among the path lengths of the connection portions 6b, 6c, 6d, and 6e. The path lengths of the connection portions 6a and 6f are larger than the path lengths of the connection portions 6c and 6d. The path lengths of the connection portions 6a and 6f are larger than any of the path lengths of the connection portions 6b, 6c, 6d, and 6e.

The present disclosure has been described in detail above on the basis of the embodiment. However, the present disclosure is not limited to the embodiment described above. The present disclosure can be variously modified without departing from the scope of the present disclosure. The present disclosure may be, for example, a combination of the embodiment and modification described above.

The coil 3 may include only the coil conductor 31 and the coil conductor 32. The coil 3 may include only the coil conductor 37 and the coil conductor 36. In the present embodiment, since the coil 3 includes the coil conductors 31 and 37 and the coil conductors 32 and 36, and the two connection portions 3a and 3f are configured. Therefore, the multilayer coil component 1 makes it possible to further improve the Q factor of the multilayer coil component.

The path length may be the minimum length from an end surface of a first end to an end surface of a second end face of each of the coil conductors 31 and 37 and respective coil conductors 32 to 36. For example, the path length may be an inner circumference from the first end face to the second end face of each of the coil conductors 31 and 37 and the respective coil conductor 32 to 36.

The connection portion 3a does not need to include the entire coil conductor 32. The connection portion 3f does not include the entire coil conductor 36.

What is claimed is:

1. A multilayer coil component comprising:
an element body;
a coil disposed in the element body;
an external electrode disposed on a surface of the element body; and
a connection conductor disposed in the element body and electrically connecting the coil and the external electrode to each other, wherein
the coil includes:
a first coil conductor located at an end of the coil and included in the same layer as the connection conductor; and
a plurality of coil conductors including a second coil conductor adjacent to the first coil conductor in a direction, the plurality of coil conductors being arranged in the direction,
the first coil conductor has a path length longer than a path length of the second coil conductor,
the first coil conductor and the second coil conductor include a first connection portion where the first coil conductor and the second coil conductor overlap each other and are physically connected to each other,
adjacent coil conductors among the plurality of coil conductors include a plurality of second connection portions where the adjacent coil conductors overlap each other and are physically connected to each other, and
an area of the first connection portion as viewed from the direction is larger than a smallest area among areas of the plurality of second connection portions as viewed from the direction.

2. The multilayer coil component according to claim 1, wherein
the area of the first connection portion as viewed in the direction is larger than any of the areas of the plurality of second connection portions as viewed in the direction.

3. A multilayer coil component comprising:
an element body;
a coil disposed in the element body;
an external electrode disposed on a surface of the element body; and
a connection conductor disposed in the element body and electrically connecting the coil and the external electrode to each other, wherein
the coil includes:
a first coil conductor located at an end of the coil and included in the same layer as the connection conductor; and
a plurality of coil conductors including a second coil conductor adjacent to the first coil conductor in a direction, the plurality of coil conductors being arranged in the direction,
the first coil conductor has a path length longer than a path length of the second coil conductor,
the first coil conductor and the second coil conductor include a first connection portion where the first coil conductor and the second coil conductor overlap each other and are physically connected to each other,
adjacent coil conductors among the plurality of coil conductors include a plurality of second connection portions where the adjacent coil conductors overlap each other and are physically connected to each other, and
the first connection portion has a path length longer than a shortest path length among path lengths of the plurality of second connection portions.

4. The multilayer coil component according to claim 3, wherein
the path length of the first connection portion is longer than any of the path lengths of the plurality of second connection portions.

5. The multilayer coil component according to claim 1, wherein
the first coil conductor has the path length longer than any of the path lengths of the plurality of coil conductors.

6. The multilayer coil component according to claim 2, wherein
the first coil conductor has the path length longer than any of the path lengths of the plurality of coil conductors.

7. The multilayer coil component according to claim 3, wherein
the first coil conductor has the path length longer than any of the path lengths of the plurality of coil conductors.

8. The multilayer coil component according to claim 4, wherein
the first coil conductor has the path length longer than any of the path lengths of the plurality of coil conductors.

9. The multilayer coil component according to claim 1, wherein
the first connection portion includes the entire second coil conductor.

10. The multilayer coil component according to claim 2, wherein
the first connection portion includes the entire second coil conductor.

11. The multilayer coil component according to claim 3, wherein
the first connection portion includes the entire second coil conductor.

12. The multilayer coil component according to claim 4, wherein
the first connection portion includes the entire second coil conductor.

13. The multilayer coil component according to claim 1, wherein
the first connection portion is curved as viewed from the direction.

14. The multilayer coil component according to claim 2, wherein
the first connection portion is curved as viewed from the direction.

15. The multilayer coil component according to claim 3, wherein
the first connection portion is curved as viewed from the direction.

16. The multilayer coil component according to claim 4, wherein
the first connection portion is curved as viewed from the direction.
